(19) United States
(12) Patent Application Publication
(10) Pub. No.: US 2005/0226620 A1
(43) Pub. Date: Oct. 13, 2005

(54) Four-port wavelength-selective crossbar switches (4WCS) using reciprocal WDM mux-demux and optical circulator combination

(76) Inventors: Mark D. Feuer, Colts Neck, NJ (US); Nicholas J. Frigo, Red Bank, NJ (US); Cedric F. Lam, Middletown, NJ (US)

Correspondence Address: Law Firm of Peter V.D. Wilde, 301 East Landing, Williamsburg, VA, 23185, US

(21) Appl. No.: 10/818,242

(22) Filed: Apr. 5, 2004

(51) Int. Cl. H04J 14/02

(52) U.S. Cl. 398/83

(57) ABSTRACT

A four-port wavelength-selective crossbar switch generates an add/drop wavelength signal from a wave division multiplexed (WDM) signal using a plurality of double-sided reflectors that selectively reflects a selected wavelength channel signal of the WDM signal through optical circulators to provide low crosstalk between the dropped and added wavelength signals. The switch also reduces the number of WDM MUX-DEMUX required to one half that compared to a traditional approach. Furthermore, the switch can be designed to be wavelength cyclic with individual free spectral ranges that can be independently set to either through or add/drop states.

### BACKGROUND OF THE INVENTION

This application claims priority to provisional U.S. Application Ser. No. 60/276,485, entitled “Four-Port Wavelength-Selective Crossbar Switches (4WCS) Using Reciprocal WDMs and Optical Circulator Combination,” invented by Mark D. Feuer et al., filed Mar. 19, 2001, and is incorporated by reference herein. Additionally, the present application is related to provisional U.S. Patent Application Ser. No. 60/276,495, entitled “Delivering Multicast Services On A Wavelength Division Multiplexed Network Using a Configurable Four-Port Wavelength Crossbar Switch” invented by Mark D. Feuer et al., filed Mar. 19, 2001, and to U.S. patent application Ser. No. ______ (Atty Docket IDS 2000-502), entitled “Delivering Multicast Services On A Wavelength Division Multiplexed Network Using a Configurable Four-Port Wavelength Selective Crossbar Switch,” invented by Mark D. Feuer et al., filed concurrently with the present application, and each of which is incorporated by reference herein.

### FIELD OF THE INVENTION

The invention relates to wavelength division multiplexed (WDM) signals. More particularly, the present invention relates to a crossbar-type switch for generating an added and dropped wavelength signals having low crosstalk between the dropped and added wavelength signals.

### DESCRIPTION OF THE RELATED ART

FIG. 1 shows a functional block diagram of a conventional four-port wavelength-selective crossbar switch (4WCS) 100. Input wavelengths λ₁, λ₂, . . . , λ_{N} are demultiplexed first by a wavelength demultiplexer 101, which can be formed by, for example, cascaded thin film filters, fiber Bragg gratings, or arrayed waveguide gratings. The demultiplexed signals are connected through an array of 2×2 crossbar switches 105 to a multiplexer 103 prior to the drop port or an output multiplexer 104. Crossbar switches 105 also connect the wavelengths corresponding to the dropped wavelengths from the add port to output multiplexer 104. The wavelengths that are to be added/dropped are selected by controlling the respective states of the crossbar switches.

A critical problem with a conventional 4WCS, such as shown in FIG. 1, is the potential for optical crosstalk in the 2×2 crossbar switches 105, thereby causing an unwanted portion of the dropped signal to coherently interfere with an added signal. The present invention provides a different implementation of a 4WCS switch and still having the functionality shown in FIG. 1.

Consequently, what is needed is a technique for adding/dropping optical signals from a WDM signal that effectively eliminates optical crosstalk between dropped and added optical signals.

### BRIEF SUMMARY OF THE INVENTION

The present invention provides a technique for adding/dropping optical signals from a WDM signal that effectively eliminates optical crosstalk between dropped and added optical signals. The advantages of the present invention are provided by an output optical circulator to the output end reciprocal WDM MUX-DEMUX. Each double-sided reflector is disposed in a path of a selected wavelength channel signal between the optical demultiplexer and the optical multiplexer, and is selectably operated so that in a first mode of operation a first side of the double-sided reflector reflects a selected wavelength channel signal corresponding to the wavelength channel signal path in which the double-sided reflector is disposed back to the second port of the input optical circulator. A second side of the doubled-sided reflector in the first mode of operation reflects an add signal having at least one wavelength corresponding to the wavelength channel signal path in which the double-sided reflector is disposed back to the second port of the output optical circulator. The selected reflected wavelength channel signal can be modulated with, for example, multicast data (as described in the provisional U.S. Patent Application Ser. No. 60/276,495, entitled “Delivering Multicast Services on a Wavelength Division Multiplexed Network Using a Configurable Four-Port Wavelength Crossbar Switch), and coupled to the add port of the output optical circulator. In a second mode of operation, each double-sided reflector allows the selected wavelength channel signal corresponding to the wavelength channel signal path in which the double-sided reflector is disposed to pass from the optical demultiplexer to the optical multiplexer. In one embodiment of the present invention, at least one double-sided reflector is a micro-electro-mechanical-system (MEMS) mirror. In an alternative embodiment of the invention, the double-sided reflector is a mechanical anti-reflection switch (MARS). In yet another alternative embodiment, the double-sided reflector is a reflective thin-film interference filter. In a further embodiment, a series of reflective thin-film interference filters corresponding to different FSRs are used in place of the double-sided reflective mirrors. This embodiment allows wavelengths corresponding to different FSRs in each wavelength channel signal to be independently set to the bar (through) or cross (add/drop) state.

The present invention also reduces the number of WDM MUX-DEMUXs required to achieve the same function by a factor of two compared with the conventional approach.

### BRIEF DESCRIPTION OF THE DRAWINGS

The present invention is illustrated by way of example and not by limitation in the accompanying figures in which like reference numerals indicate similar elements and in which:

FIG. 1 shows a functional block diagram of a conventional four-port wavelength-selective crossbar switch (4WCS);

FIG. 2 shows a functional block diagram of a four-port wavelength-selective crossbar switch (4WCS) according to the present invention;

FIG. 3 shows a functional block diagram of a four-port wavelength-selective crossbar switch (4WCS) according to the present invention having a free spectral range; and

FIG. 4 shows a functional block diagram of a four-port wavelength-selective crossbar switch (4WCS) 400 according to the present invention that provides even more flexibility than other embodiments of the present invention without increasing the number of WGR ports.

### DETAILED DESCRIPTION OF THE INVENTION

The present invention provides a configurable four-port wavelength-selective optical crossbar switch (4WCS) that is capable of dropping any subset of input wavelengths from the input port to a drop port. The same wavelengths dropped at the drop port can be added from an add port to the output port.

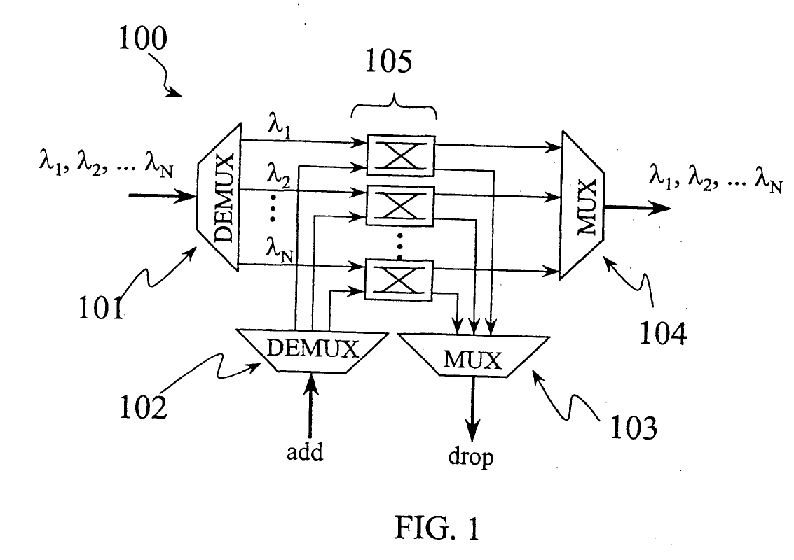

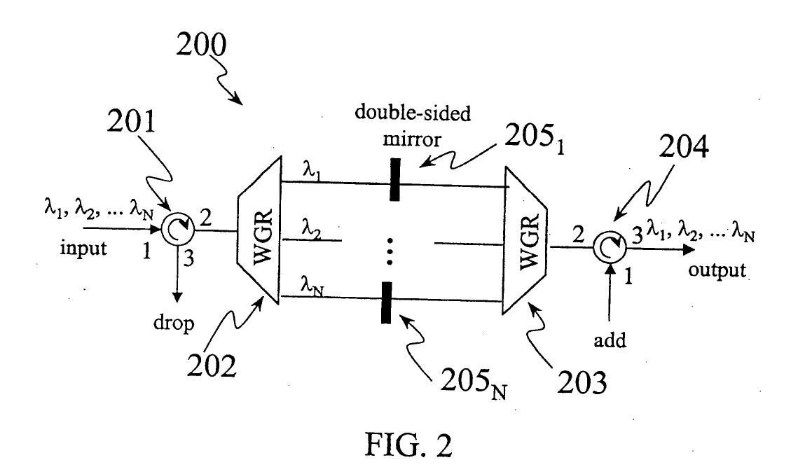

FIG. 2 shows a functional block diagram of a four-port wavelength-selective crossbar switch (4WCS) 200 according to the present invention. Switch 200 includes an input optical circulator 201, an input bidirectional wavelength demultiplexer 202 (which is the input end reciprocal WDM MUX-DEMUX), a bi-directional wavelength multiplexer 203 (which is the output end reciprocal WDM MUX-DEMUX), and an output optical circulator 204. Input optical circulator 201 includes a “drop” port, and output optical circulator 204 includes an “add” port. Input demultiplexer 202 and output multiplexer 203 can each be a waveguide grating router (WGR) that separates the different wavelengths of a WDM signal into different channels, or arms, in a well-known manner. Optical circulators 201 and 204 separate the in-coming and outgoing waves, as described in detail below, and reduce the total number of WGR ports and devices to half in comparison to a conventional 4WCS, such as shown in FIG. 1. As opposed to the conventional approach, switch 200 operates in a unidirectional manner and is not reversible for bi-directional traffic within a single fiber.

Switch 200 also includes a plurality of removable, double-sided optical reflectors 205₁-205_{N} that are each respectively positioned so that an optical reflector can be inserted into a wavelength channel, or arm, between input demultiplexer 202 and output multiplexer 203. Each reflector 205 provides extremely high isolation between an added and a dropped channel because the reflectivity and the optical thickness of an optical reflector 205 are preferably large. While the embodiment of the present invention shown in FIG. 2 includes a reflector 205 for each wavelength channel, it should be understood that some wavelength channels might not include a reflector 205. Accordingly, wavelengths in those channels can only go through switch 200 without being added or dropped.

Reflectors 205 can use any design that is capable of switching from two-sided back-reflection to a full-transmitting state or mode of operation, that is, an “IN” state and an “OUT” state, respectively. Reflectors 205 can use, for example, micro-electro-mechanical-system (MEMS) technology for selectably inserting or removing a two-sided mirror from an optical beam in a well-known manner. Moreover, because both WGR devices and MEMS devices are fabricated on silicon substrates, WGR devices 202 and 203, and removable reflectors 205 for an entire 4WCS switch according to the present invention can be fabricated on a single silicon chip.

WGR devices 202 and 203 provide reciprocal operation, so when a reflector 205 is in the “IN” state, the wavelength corresponding to the reflector is reflected back to a WGR device (input demultiplexer 202 and output multiplexer 203), thereby causing a wavelength in a particular arm to be added/dropped. When a reflector 205 is in the “OUT” state, the wavelength corresponding to the reflector is set to the through state, or the express state, and the beam thereby passes through the corresponding arm. For example, when reflector 205₁ is set to the “IN” state, input wavelength λ₁ of an input WDM signal is reflected back through input demultiplexer 202 to input circulator 201. (For this portion of the wavelength λ₁ signal path, input demultiplexer 202 operates as a multiplexer.) Reflected wavelength λ₁ travels clockwise around optical circulator 201 and is output from the drop port. Dropped wavelength λ, can be modulated with, for example, downstream data from another network node for the local node. Wavelength λ₁ can then be added back to the WDM signal through the add port of output optical circulator 204. Wavelength λ₁ travels clockwise around output optical circulator 204 and is output from circulator 204 in a direction toward multiplexer 203 (which, for this portion of the signal path of wavelength λ₁, operates as a demultiplexer). Wavelength λ₁ is reflected by reflector 205₁ back to output multiplexer 203 and is added back to the WDM signal. The added wavelength λ₁ can be modulated with, for example, upstream data from the local node to the next network node.

There are many ways of implementing reflectors 205. For example, reflectors 205 can be made similar to MEMS reflectors that are used in an optical MEMS cross-switch. That is, MEMS reflectors 205 can be flipped in a vertical or horizontal position, corresponding to the IN and OUT states of reflectors 205. Alternatively, rather than physically moving a reflector out of a beam, a reflector may be altered internally so that the reflector becomes non-reflective at the wavelength of interest. Examples of this approach could include a mechanical anti-reflection switch (MARS) or devices that are based on a frustrated total internal reflection.

Additional system capabilities are provided when an input demultiplexer and an output multiplexer are wavelength-cyclic, that is, have a filter response function that repeats over a period of wavelengths, which is called the free spectral range (FSR). A wavelength cyclic property can be designed into a waveguide grating router, Mach-Zehnder interferometers, Fabry-Perot filters etc., to provide a particular FSR. For example, when a WGR is wavelength cyclic, the output from port i will include wavelength and all wavelengths λᵢ+m×Λ, where m is an integer and Λ is the free spectral range. Accordingly, a single filter element can provide wavelength routing for many distinct wavelength channels. One important network application might be to use different FSRs for delivering different services and to further separate the different services at each node of an optical network using coarse optical filters.

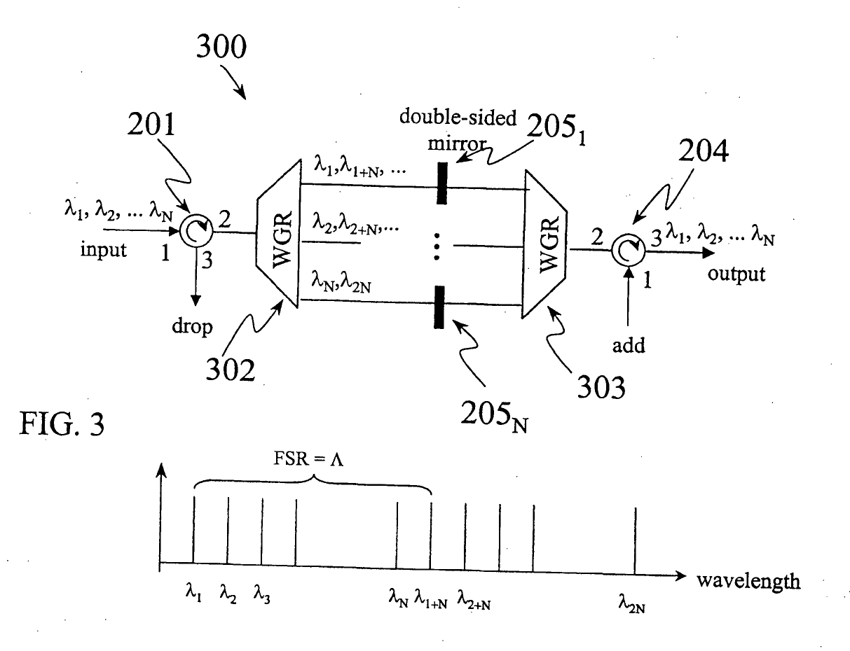

FIG. 3 shows a functional block diagram of a four-port wavelength-selective crossbar switch (4WCS) 300 according to the present invention having a free spectral range (FSR). Switch 300 includes an input demultiplexer 302 and/or an output multiplexer 303 that provide an FSR. The bottom of FIG. 3 illustrates the optical spectrum of the input WDM signal and the FSR of the WDM MUX-DEMUX.

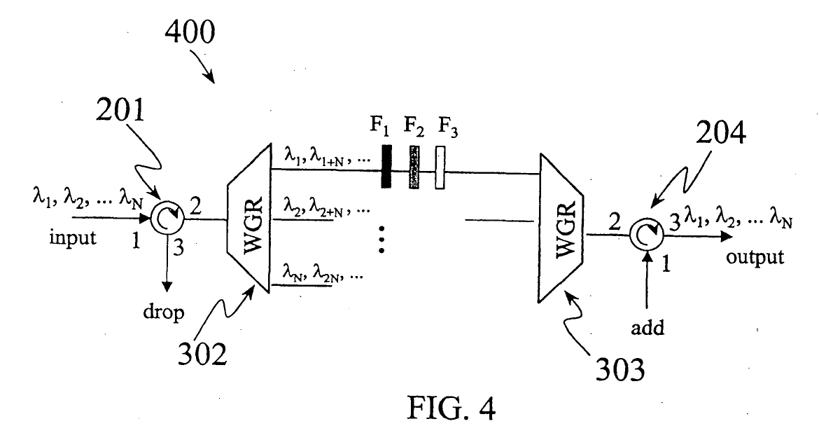

FIG. 4 shows a functional block diagram of a four-port wavelength-selective crossbar switch (4WCS) 400 according to the present invention that provides even more flexibility than other embodiments of the present invention without increasing the number of WGR ports. Instead of including all-wavelength reflectors between the input demultiplexer and the output multiplexer, such as shown in FIG. 2, each reflector can be replaced with a series of reflective filters F, such as thin-film interference filters. For example, in FIG. 4, F₁, F₂ and F₃ represent filters that reflect three independent FSRs and let other optical signals pass. Similar to a double-sided mirror, each filter can be independently set to the IN or OUT position. Consequently, each wavelength in every free spectral range can be independently added/dropped or passed through, extending the functionality and flexibility of the 4WCS.

The advantage of added/dropped isolation of the alternative embodiment of FIG. 4 is obtained at the expense of potential self-homodyne interference. The self-homodyne interference is due to imperfect filter reflectivities and scattering at the multiple filter surfaces. This complicated effect is not-related to the claims in the current invention and will not be further described here.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1-10. (canceled)

11. Method for providing a drop signal function in a wavelength division multiplexed (WDM) system comprising:
(a) providing a first optical circulator, the first circulator having a first port, a second port, and a third (drop) port,
(b) inserting a WDM signal having a plurality of wavelengths in the first port of the first optical circulator,
(c) coupling the WDM signal from the first port of the first optical circulator to the second port,
(d) transmitting the WDM signal from the second port of the first optical circulator to a demultplexer,
(e) separating the WDM signal into at least three signals wavelengths λ₁, λ₂ and λ₃,
(f) passing signal wavelength λ₁ through a first selective reflector to a multiplexer,
(g) passing signal wavelength λ₂ through a second selective reflector to the multiplexer,
(h) combining signal wavelengths λ₁ and λ₂ in the multiplexer to form a WDM signal of λ₁ and λ₂,
(j) passing drop signal wavelength λ 3 through a third selective reflector,
(k) reflecting wavelength λ₃ back to through the demultiplexer to the second port of the first circulator,
(l) coupling wavelength λ₃ from the second port of the first circulator to third (drop) port of the first circulator,
(m) extracting signal wavelength λ₃ from the third (drop) port of the first circulator, thereby completing the drop function.

12. The method of claim 11 further including providing an add signal function for the WDM system by steps comprising:
(O) providing a second optical circulator, the second circulator having a first port, a second port, and a third (add) port,
(p) inserting the WDM signal of λ₁ and λ₂ in the first port of the second optical circulator,
(q) coupling the WDM signal of λ₁ and λ₂ from the first port of the second optical circulator to the second port,
(r) adding a signal wavelength (add signal) in the third (add) port of the second optical circulator,
(s) coupling the add signal from the third port of the second optical circulator to the first port,
(t) transmitting the add signal from the second optical circulator through the multiplexer to a reflector,
(u) reflecting the add signal through the multiplexer, and adding the add signal to the WDM signal of λ₁ and λ₂ to complete the add function.

13. The method of claim 12 wherein the reflecting step in steps (k) and (u) is implemented using double-sided reflectors.

14. The method of claim 12 wherein demultiplexer and multiplexer are reciprocal.

15. The method of claim 12 wherein demultiplexer and multiplexer are each a waveguide grating router.

16. The method of claim 13 wherein the double-sided reflectors are implemented using micro-electro-mechanical-system (MEMS) mirrors.

17. The method of claim 12 wherein the demultiplexer, multiplexer and the double-sided reflectors are fabricated on a silicon substrate.

18. The method of claim 12 wherein the WDM signal includes a plurality of wavelengths within a predetermined free spectral range (FSR).

19. The method of claim 12 wherein at least one of the demultiplexer and the multiplexer is wavelength-cyclic.

20. The method of claim 13 wherein the reflecting steps are implemented using a mechanical anti-reflection switch (MARS).

21. The method of claim 13 wherein the reflecting steps are implemented using reflective thin-film interference filters.

22. The method of claim 21 wherein thin-film interference filters each correspond to a different free spectral range (FSR) of a wavelength cyclic multiplexer and demultiplexer and each filter is set in either IN or OUT state.
